(19) United States
(12) Patent Application Publication
(10) Pub. No.: US 2007/0104614 A1
(43) Pub. Date: May 10, 2007

(54) Automatic chemistry analyzer and analyzing method

(75) Inventors: Wei Wang, Nanshan (CN); Chuanfen Xie, Nanshan (CN); Quan Li, Nanshan (CN); Zhi Xu, Nanshan (CN)

Correspondence Address: Gerald Chan;Bingham McCutchen LLP, Suite 1800, Three Embarcadero Center, San Francisco, CA, 94111-4067, US

(73) Assignee: SHENZHEN MINDRAY BIO-MEDICAL ELECTRONICS CO., LTD., Nanshan (CN)

(21) Appl. No.: 11/317,559

(22) Filed: Dec. 22, 2005

(30) Foreign Application Priority Data
Nov. 10, 2005 (CN) 200510101335.3

(51) Int. Cl. G01N 35/00

(52) U.S. Cl. 422/64

(57) ABSTRACT

The present invention relates to an automatic chemistry analyzer comprising a reaction disk assembly (1), a sample and reagent disk assembly (2), a probe assembly (3) and a stirring assembly (4). A single probe (5) is used to dispense both the reagent and the sample into the reaction vessels. A pre-heating device disposed in the mechanical arm (6) for supporting the probe (5) pre-heats the reagent sucked into the probe to an appropriate temperature. The reaction vessels are disposable and may be replaced manually. The automatic chemistry analyzer may run single-reagent tests or double-reagent tests. According to the automatic chemistry analyzer of the present invention, the interval between injecting the first reagent of a test and injecting the sample of the same test may be 5.5 operation periods so that the first reagent in the reaction vessel may be maintained at or near an appropriate reaction temperature (37° C.). In a process of running a double-reagent test, the incubation time between injecting the sample and injecting the second reagent is set freely by the operator according to the requirements of the test. The automatic chemistry analyzer and the analyzing method according to the present invention may improve the test correctness.

### FIELD OF THE INVENTION

The present invention relates to a method and apparatus for analyzing liquid sample, and more particularly to an automatic chemistry analyzer capable of automatically analyzing a component concentration in a liquid sample.

### DESCRIPTION OF THE BACKGROUND ART

An automatic chemistry analyzer is well-known and used widely in the analysing field. Such analyzer comprises generally a reaction disk (including a thermostat for maintaining a constant temperature), a sample disk (or a sample orbit), a reagent disk, a sample-dispensing mechanism, a reagent-dispensing mechanism, a mixing mechanism, a washing device for rinsing reaction vessels and a system operated by a user. In a simply constructed chemical analyzer, the sample disk and the reagent disk are integrated into one piece, and one probe is used to transfer both the reagent and the sample. Such chemical analyzer was disclosed in U.S. Pat. No. 5,051,238 and U.S. Pat. No. 5,314,825. In the system disclosed in U.S. Pat. No. 5,051,238, the sample disk and the reagent disk are fixed to a common drive shaft with the reagent disk being outside of the sample disk. Around the outer circumference of the reagent disk is disposed a reagent refrigerating module. One probe is used to transfer both the reagent and the sample into the reaction vessel. The washing device rinses the reaction vessel to use the same repeatedly. In the analyzer disclosed in U.S. Pat. No. 5,314,825, the sample disk and the reagent disk are also integrated into one tray, and one probe is used to transfer both the reagent and the sample into a disposable reaction vessel. The reaction vessel filled with the reaction solution is discharged by a special transferring device after reacting.

No separate stirring mechanism is provided in the conventional analyzer described above. U.S. Pat. No. 5,051,238 uses a vibratory driving device to mix the reagent and the sample and U.S. Pat. No. 5,314,825 mix centrifugally the reagent and the sample during rotation of the reaction disk. They can't mix very effectively the reagent and the sample.

In addition, another simple analyzer is available on the market, which washes automatically the reaction vessel with an automatic washing system after reaction and also has no separate stirring mechanism. The analyzer first sucks the first reagent into one probe, then sucks a tiny amount of air into the probe, sucks the sample into the probe after washing the outwall of the probe, and then injects the sucked reagent and sample into a reaction vessel to begin reaction or incubation. Since the temperate of the reagent can't be risen before reacting, it is not ensured that the test is performed at a special temperature (for example 37° C.), thereby affecting adversely the reaction effect and the test correctness. Furthermore, since there is not any separate stirring mechanism and the mixing of the reagent and the sample is conducted by pressure injection, it is also impossible to achieve a desirable mixing.

### SUMMARY OF THE INVENTION

An object of the invention is to overcome the defects and problems in the prior arts and provide an automatic chemistry analyzer and an analyzing process, which may improve the test correctness.

According to the present invention, the reaction disk assembly includes a built-in incubation constant temperature system which is heated by warm air. The sample disk and the reagent disk are fixed to a common drive shaft with the reagent disk being inside of the sample disk. There is also a refrigerating module. A single probe having a capacity of dispensing 3-450 microliters dispenses reagent or sample into the reaction vessels. The reaction vessels are disposable and may be replaced manually.

According to one aspect the present invention, there is provided an automatic chemistry analyzer comprising:

a reaction disk assembly comprising a turntable, a first driving mechanism for driving the turntable to rotate, a plurality of reaction vessels disposed successively around the circumference of the turntable, and an optical measuring mechanism for measuring the light absorbence of each reaction vessel disposed aside of the turntable, wherein the turntable and the reaction vessels being disposed in a close and temperature-controlled cavity;

a sample and reagent disk assembly comprising a sample and reagent support and a second driving mechanism for driving the sample and reagent support to rotate, a plurality of holes for receiving the sample vessels and a plurality of holes for receiving the reagent vessels disposed on the sample and reagent support, and a refrigerating module disposed below the sample and reagent support to maintain the reagent at a low temperature;

a probe assembly comprising a probe, a first mechanical arm for supporting the probe, a first driving module for driving the first mechanical arm, a syringe, and fluid path which connects the syringe and the probe, wherein the probe being used to inject both the reagent and the sample into the reaction vessels;

a stirring assembly comprising a stirring rod, a second mechanical arm for supporting the stirring rod, a second driving module for driving the second mechanical arm, a stirring driving mechanism disposed in the second mechanical arm to drive the stirring rod; and

a circuit and a processing soft for controlling the reaction disk assembly, the sample and reagent disk assembly, the probe assembly and the stirring assembly to operate harmoniously in analyzing process.

Preferably, the reaction vessels are disposable and a window is disposed over the reaction disk to replace manually the reaction vessels.

Preferably, the reaction vessels are disposed around the circumference of the turntable at an equal interval and divided into a plurality of reaction vessel packs each including a group of reaction vessels connected to each other in a segment shape.

Preferably, the sample and reagent support includes an inner circle and an outer circle, the sample vessels are disposed in the outer circle at an equal interval and the reagent vessels are disposed in the inner circle at an equal interval.

Preferably, the probe assembly further comprises a capacitive liquid level detector to stop the probe descent when the tip of the probe contacts the surface of liquid and a pre-heating device disposed inside of the first mechanical arm to pre-heat the reagent sucked into the probe to an appropriate temperature, the first mechanical arm is attached to the top end of a first spline shaft, and upward and downward movement and rotation of the first spline shaft are controlled precisely by two stepping motors of the first driving module.

Preferably, the stirring driving mechanism includes a DC motor connected to the stirring rod to rotate the stirring rod, the second mechanical arm is attached to the top end of a second spline shaft, and upward and downward movement and rotation of the spline shaft are controlled precisely by two stepping motors of the second driving module.

Preferably, the optical measuring mechanism comprises a plurality of optical measuring channels each corresponding to one measured wavelength, and the reaction vessels pass through the optical measuring channels at a constant velocity to measure the light absorbence of each reaction solution.

Preferably, the temperature-controlled cavity includes a close cavity and a temperature control system to maintain the reaction temperature at or near a special temperature during chemical test, a heater and an axial fan are disposed in the temperature-controlled cavity, and the reaction vessels and the turntable are disposed in the temperature-controlled cavity.

Preferably, the special temperature is human body temperature.

Preferably, the refrigerating module includes a semiconductor refrigerating element, a heat dispersion passage, a close and thermally insulated cavity and a refrigerating control system to maintain the temperature of the reagent at a lower temperature, thereby reducing volatilisation and elongating period of validity of the reagent.

Preferably, the first driving mechanism includes a first bearing seat for supporting the turntable, a stepping motor and a synchronizing belt, the first bearing seat is driven by the stepping motor via the synchronizing belt to rotate and stop precisely the turntable so that one special reaction vessel is located in an injecting station or a stirring station.

Preferably, the second driving mechanism includes a second bearing seat for supporting the sample and reagent support, a stepping motor and a synchronizing belt, the bearing seat is driven by the stepping motor via the synchronizing belt to rotate and stop precisely the sample and reagent support so that one special reagent vessel or sample vessel is located in an reagent-sucking station or a sample-sucking station.

Preferably, there are eighty reaction vessels consisting of eight reaction vessel packs each including ten reaction vessels connected to each other, and the reaction vessels is positioned circumferentially by engaging the positioning holes formed in the reaction vessel pack with the corresponding positioning pins provided on the turntable to facilitate manually replacing the reaction vessels.

According another aspect of the present invention, there is provided an analyzing process for running a single-reagent test using the automatic chemistry analyzer as described above, the analyzing process comprising the following steps:

a). powering-on to self-test and initialize the chemistry analyzer;

b). placing new reaction vessels onto the turntable according to the indication of the chemistry analyzer and measuring the light absorbence of the empty reaction vessels;

c). using the probe to suck a fixed volume of reagent from a reagent vessel, pre-heating the reagent sucked into the probe by the pre-heating device disposed in the mechanical arm of the probe, injecting the pre-heated reagent into a designated reaction vessel and washing the probe after completion of injection;

d). heating the reagent in the reaction vessel inside of the temperature-controlled cavity of the reaction disk assembly for several operation periods to an appropriate test temperature;

e). using the probe to suck a fixed volume of sample from a sample vessel and inject the same into the reaction vessel, and washing the probe;

f). inserting the stirring rod into the reaction vessel to mix the reagent and the sample in the reaction vessel, and washing the stirring rod after completion of stirring;

g). measuring periodically the light absorbence of the reaction vessel filled with the mixed reagent and sample by the optical measuring mechanism; and

h). computing and outputting the test results.

According another aspect of the present invention, there is provided an analyzing process for running a double-reagent test using the automatic chemistry analyzer as described above, the analyzing process comprising the following steps:

a). starting and initializing the chemistry analyzer;

b). placing new reaction vessels onto the turntable according to the indication of the analyzer and measuring the light absorbence of the empty reaction vessels;

c). using the probe to suck a fixed volume of the first reagent from a reagent vessel, pre-heating the first reagent sucked into the probe by the pre-heating device disposed in the mechanical arm of the probe, injecting the pre-heated first reagent into a designated reaction vessel and washing the probe after completion of injection;

d). heating the first reagent in the reaction vessel inside of the temperature-controlled cavity of the reaction disk assembly for several operation periods to an appropriate reaction temperature;

e). using the probe to suck a fixed volume of sample from a sample vessel and inject the same into the reaction vessel, and washing the probe;

f). inserting the stirring rod into the reaction vessel to mix the first reagent and the sample in the reaction vessel, and washing the stirring rod after completion of stirring;

g). using the probe to suck a fixed volume of second reagent from a reagent vessel, pre-heating the second reagent sucked into the probe by the pre-heating device disposed in the mechanical arm of the probe, injecting the pre-heated second reagent into the reaction vessel and washing the probe following injection after an incubation time necessary for the double-reagent test has passed;

h). inserting the stirring rod into the reaction vessel to mix the first reagent, the sample and the second reagent in the reaction vessel, and washing the stirring rod after completion of stirring;

i). measuring the light absorbence of the reaction vessel filled with the reaction solution by the optical measuring mechanism; and

j). computing and outputting the test results.

According another aspect of the present invention, there is provided an analyzing process for testing successively a plurality of single-reagent tests and double-reagent tests using the automatic chemistry analyzer as described above, the analyzing process comprising the following steps:

a). starting and initializing the chemistry analyzer, and numbering all tests in order;

b). placing new reaction vessels onto the turntable according to the indication of the analyzer and measuring the light absorbence of the empty reaction vessels;

c). using successively the probe to suck the reagent or the first reagent corresponding to the first to the N^{th} test from a reagent vessel and inject the same into the first to the N^{th} reaction vessel, and washing the probe after completion of each injection during each operation period from the first to the N^{th} operation period;

d). using the probe to suck the reagent or the first reagent corresponding to the N+1^{th} test from the reagent vessel and inject the same into the N+1^{th} reaction vessel, washing the probe, using the probe to suck the sample corresponding to the first test from the sample vessel and inject the same into the first reaction vessel, washing the probe after injection of the sample, then using the stirring rod to stir the first reaction vessel into which the sample is injected and washing the stirring rod during the N+1^{th} operation period; e). using the probe to suck the reagent or the first reagent corresponding to the successively tests following the N+1^{th} test from the reagent vessels and inject the same into the successive reaction vessels following the N+1^{th} reaction vessel, washing the probe, using the probe to suck the sample corresponding to the successive tests following the first test and inject the same into the successive reaction vessels following the first reaction vessel, washing the probe after injection of the sample, then using the stirring rod to stir the reaction vessel into which the sample is injected and washing the stirring rod during each operation period after the N+1^{th} operation period;

f). using the probe to suck the second reagent necessary for a double-reagent test from the reagent vessels and inject the same into the respective reaction vessel, washing the probe, then using the stirring rod to stir the reaction vessels into which the second reagent is injected and washing the stirring rod during an operation period after an incubation time necessary for the double-reagent test has passed;

g). restoring the operation of injecting the reagent or the first reagent and the sample during each operation period after completion of injecting the second reagent;

h). using successively the probe to suck the sample corresponding to the last N tests and inject the same into the respective reaction vessels, washing the probe after each injection of the sample, then using the stirring rod to stir the reaction vessels into which the sample is injected and washing the stirring rod respectively during each operation period;

i). measuring the light absorbence of all the reaction vessels filled with the reaction solution by the optical measuring mechanism during each operation period;

j). replacing manually the reaction vessels according to the indication of the analyzer after the reactions in the reaction vessels has completed; and

k). computing and outputting the test results.

Preferably, the appropriate reaction temperature is at or near 37° C.

Preferably, the step a) comprises resetting the reaction disk assembly, the sample and reagent disk assembly, the probe assembly and the stirring assembly, electrifying the optical measuring mechanism, performing temperature incubation in the temperature-controlled cavity; and starting the test only after the optical measuring mechanism is stable and the temperature-controlled cavity is at a constant temperature of 37° C.

Preferably, the value of N is in a range of between 1 and 30.

Preferably, the value of N is 5, 6 or 7.

Compared with the conventional chemistry analyzer, the automatic chemistry analyzer according to the present invention has the following advantages:

By optimising the structure of analyzer and the analyzing process, the reaction vessels into which the first reagent is injected may be heated for some time (5.5 period in the illustrated embodiment) and then the sample may be injected into it so that the reaction temperature is maintained at or near 37° C. In running a double-reagent test, the incubation time between injecting the sample and injecting the second reagent is set freely by the operator according to the requirements of the test so that there may be a difference in incubation time for the double-reagent test, thereby enhancing the reaction correctness. With a separate stirring rod, the reagent and the sample may be mixed uniformly in the reaction vessel. Furthermore, with the cheap and disposable reaction vessels, it is convenient to operate and it is possible to improve the measurement of the light absorbence.

### BRIEF DESCRIPTION OF THE DRAWING

FIG. 1 is a schematic perspective view showing an automatic chemistry analyzer according to the present invention.

FIG. 2 is a schematic view of the automatic chemistry analyzer according to the present invention, with the housing removed to show the main components of the analyzer.

FIG. 3a is a schematic perspective view showing a reaction vessel pack of the automatic chemistry analyzer according to the present invention.

FIG. 3b is a top view of the reaction vessel pack.

FIG. 4 is a schematic perspective view showing a turntable of the automatic chemistry analyzer according to the present invention.

FIG. 5 is a flow chart explanatory of the analyzing process executed with the automatic chemistry analyzer according to the present invention.

FIG. 6 is a timing diagram of actions of each assembly during the period for injecting the first reagent and the sample.

FIG. 7 is a timing diagram of actions of each assembly during the period for injecting the second reagent.

### DETAILED DESCRIPTION OF THE PREFERRED EMBODIMENT

The embodiment of the automatic chemistry analyzer and the analyzing process according to the present invention will be described in detail with reference to the drawings.

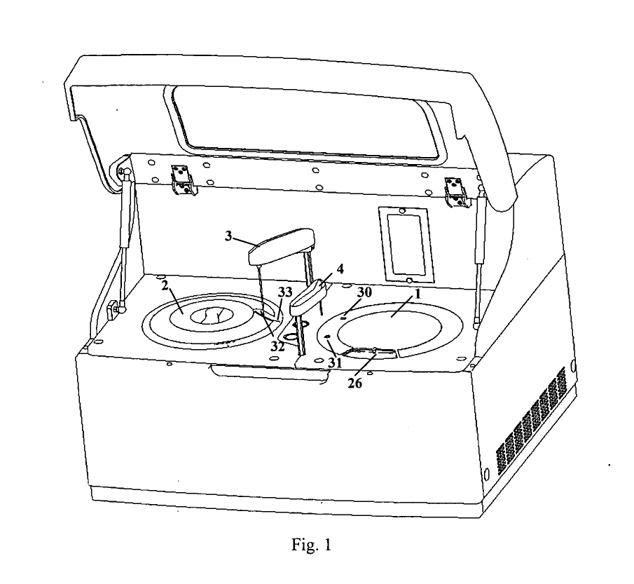

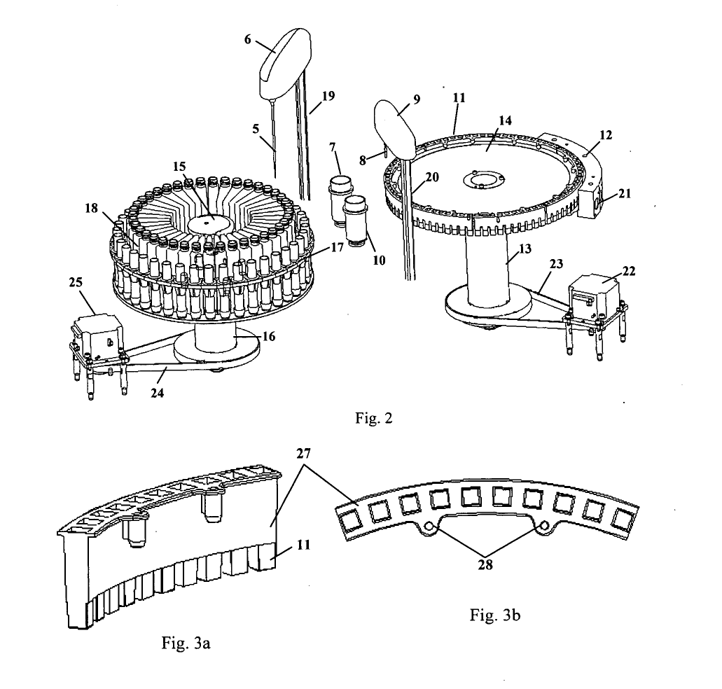

As shown in FIGS. 1 and 2, the automatic chemistry analyzer according to the present invention comprises substantially a reaction disk assembly 1, a sample and reagent disk assembly 2, a probe assembly 3, a stirring assembly 4, a control circuit and control soft.

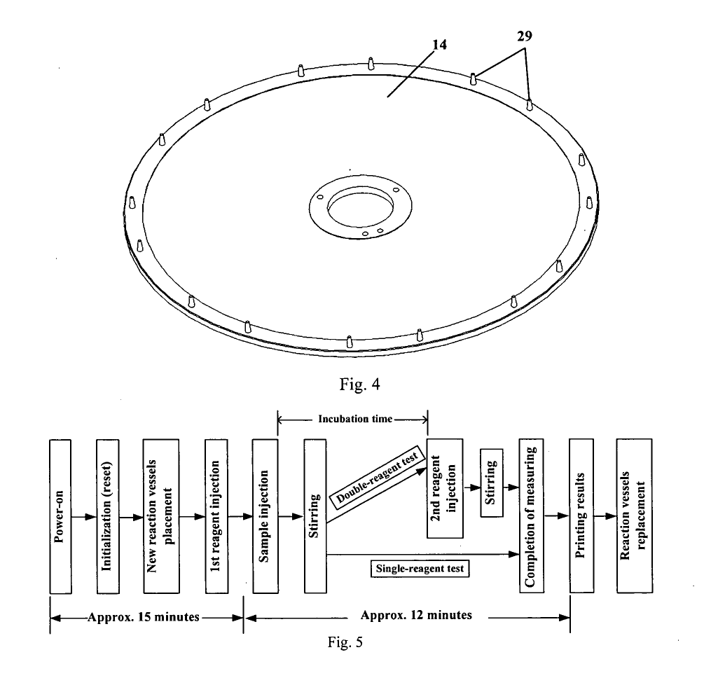

The reaction disk assembly 1 comprises a turntable 14 and a first driving mechanism for driving the turntable 14 to rotate. A plurality of disposable reaction vessels 11 are disposed around the circumference of the turntable 14 at equal interval. In the illustrated embodiment, eight reaction vessel packs 27 each including ten reaction vessels 11 (FIG. 3) are disposed around the circumference of the turntable 14. The reaction vessels may be positioned by engaging the positioning hole 28 formed in the reaction vessel packs 27 with the corresponding positioning pins 29 provided on the turntable 14 (FIG. 4) to facilitate manually replacing the reaction vessels 11. The operator may replace the reaction vessel packs 27 through a window 26.

An optical measuring mechanism 12 for measuring the light absorbence of the reaction vessels 11 is disposed aside of the turntable 14. The turntable 14 and the reaction vessels 11 are disposed in a close and temperature-controlled cavity. The optical measuring mechanism 12 comprises eight optical measuring channels 21 each corresponding to one measured wavelength. The reaction vessels 11 pass through the optical measuring channels at a constant velocity to measure the light absorbence of each reaction solution. The temperature-controlled cavity includes a close heating cavity and a control system to maintain the reaction temperature at or near a special temperature such as human body temperature during test. A heater and an axial fan are disposed in the temperature-controlled cavity. The first driving mechanism for driving the turntable 14 to rotate includes a bearing seat 13, a stepping motor 22 and a synchronizing belt 23. The bearing seat 13 is driven by the stepping motor 22 via the synchronizing belt 23 to rotate and stop precisely the turntable 14 so that the special reaction vessel 11 is located in an injecting station 30 or a stirring station 31. The injection of the sample and the reagent and the stirring will be completed by a probe and a stirring rod.

The sample and reagent disk assembly 2 comprises a sample and reagent support 15 and a second driving mechanism for driving the sample and reagent support 15 to rotate. Forty holes 18 for receiving the reagent vessels and forty holes 17 for receiving the sample vessels are disposed on the sample and reagent support 15 along an inner circle and an outer circle respectively. A refrigerating module is disposed below the sample and reagent support 15 to maintain the reagents at a low temperature. The refrigerating module includes a semiconductor refrigerating element, a heat dispersion passage, a close and thermally insulated cavity and a control system. The refrigerating module may maintain the temperature of the sample and reagent at 4-15° C. to elongate period of validity of the reagent and reduce volatilisation. The second driving mechanism for driving the sample and reagent support 15 to rotate includes a bearing seat 16 for supporting rotatably the sample and reagent support 15, a stepping motor 25 and a synchronizing belt 24. The bearing seat 16 is driven by the stepping motor 25 via the synchronizing belt 24 to rotate and stop precisely the sample and reagent support 15 so that the special reagent or sample vessel is located in an reagent-sucking station 32 or a sample-sucking station 33. The suction of the reagent or the sample will be completed by a probe.

The probe assembly 3 comprises a probe 5, a first mechanical arm 6 for supporting the probe 5, a first driving module for driving the first mechanical arm 6, a syringe, and a fluid path which connects the syringe and the probe. In the present invention, a single probe 5 is used to inject both the reagent and the sample into the reaction vessels 11. The probe 5 includes a capacitive liquid level detector, capable of adjusting the position of the tip of the probe 5 according to the amount of the discharged liquid, thereby reducing maximally cross contamination. The probe 5 also has a function of anticollision. When the probe 5 is subject to a resistance or collision, it stops automatically and sends out a warning signal. A pre-heating device is disposed inside of the first mechanical arm 6 to pre-heat the reagent sucked into the probe 5 to an appropriate temperature. The first mechanical arm 6 is attached to the top end of a spline shaft 19. Upward and downward movement and rotation of the spline shaft 19 are controlled precisely by two stepping motors of the first driving module.

The stirring assembly 4 comprises a stirring rod 8, a second mechanical arm 9 for supporting the stirring rod 8, a second driving module for driving the second mechanical arm 9, a stirring driving mechanism for rotating the stirring rod 8. The stirring rod 8 stirs the reaction solutions in the reaction vessels 11 to mix them uniformly. The stirring driving mechanism includes a DC motor connected to the stirring rod 8 to rotate the stirring rod 8. The second mechanical arm 9 is attached to the top end of a spline shaft 20. Upward and downward movement and rotation of the spline shaft 20 are controlled precisely by two stepping motors of the second driving module.

The circuit and processing soft are used to control the reaction disk assembly 1, the sample and reagent disk assembly 2, the probe assembly 3 and the stirring assembly 4 so that they operate harmoniously in analyzing process. The circuit and processing soft are well known in the art and the description regarding them is omitted.

During the analyzing process, each of these assemblies operates periodically. The operation during each period may include for example rotating the reaction disk, injecting the reagent, injecting sample and stirring the reaction solution. The operation during each period may be variable. Such period is called an operation period. The test executed with the chemistry analyzer includes a series of operation periods.

FIG. 5 is a flow chart explanatory of the analyzing process executed with the automatic chemistry analyzer according to the present invention. The automatic chemistry analyzer according to the present invention may perform both single-reagent test and double-reagent test. During the analyzing process of a test, the reagent (the first reagent) is first injected into a designated reaction vessel and the sample is injected into the reaction vessels after N periods. For a double-reagent test, the second reagent is injected into the reaction vessels after the sample is injected and a special incubation time has passed. The incubation time may be set by the operator according to the requirements of the test. The value of N is dependent on the setting of the operation period of the analyzer and the rate at which the reagent is heated in the temperature-controlled cavity. The value of N should ensure that the reagent in the reaction vessel is heated to an appropriate test temperature (for example at or near 37° C.). In the illustrated embodiment, the operation period is set to 18 seconds and N is 5.5 so that the temperature-rise time is about 1 minute and 39 seconds.

If a plurality of single-reagent tests or double-reagent tests are performed, injecting the reagents and samples and stirring the reaction solution are performed successively. The test includes the following steps:

a. electrifying and initializing the chemistry analyzer, including resetting the reaction disk assembly 1, the sample and reagent disk assembly 2, the probe assembly 3 and the stirring assembly 4, electrifying a light source of the optical measuring mechanism 12, performing temperature incubation in the temperature-controlled cavity; and starting the test only after the light source is stable and the temperature-controlled cavity is at a constant temperature of 37° C.;

b. placing new reaction vessels onto the turntable 14 according to the indication of the analyzer and measuring the light absorbence of the empty reaction vessels;

c. using the probe 5 to suck the reagent (the first reagent) corresponding to the first test to the fifth test from the reagent vessels and inject the same into the first reaction vessel to the fifth reaction vessel, and washing the probe 5 after each injection of the reagent during each operation period from the first operation period to the fifth operation period;

d. using the probe 5 to suck the reagent (the first reagent) corresponding to the sixth test from the reagent vessel and inject the same into the sixth reaction vessel, washing the probe 5, using the probe 5 to suck the sample corresponding to the first test and inject the same into the first reaction vessel, washing the probe 5 after injection of the sample, then using the stirring rod 8 to stir the first reaction vessel into which the sample is injected and washing the stirring rod 8 during the sixth operation period;

e. using the probe 5 to suck the reagent (the first reagent) corresponding to the successive test following the sixth test item from the reagent vessel and inject the same into the successive reaction vessel following the sixth reaction vessel, washing the probe 5, using the probe 5 to suck the sample corresponding to the successively test following the first test and inject the same into the successive reaction vessel following the first reaction vessel, washing the probe 5 after each injection of the sample, then using the stirring rod 8 to stir the reaction vessel into which the sample is injected and washing the stirring rod 8 during each operation period after the sixth operation period;

f. using the probe 5 to suck the second reagent necessary for a double-reagent test from the reagent vessel and inject the same into the respective reaction vessel, washing the probe 5, then using the stirring rod 8 to stir the reaction vessel into which the second reagent is injected and washing the stirring rod 8 during an operation period after an incubation time necessary for the two-reagent test has passed;

g. restoring the operation of injecting the reagent (or the first reagent) and the sample during each operation period after completion of injecting the second reagent;

h. using the probe 5 to suck the sample corresponding to the last five tests and inject the same into the respective reaction vessels, washing the probe 5 after each injection of the sample, then using the stirring rod 8 to stir the reaction vessel into which the sample is injected and washing the stirring rod 8 respectively during each operation period;

i. measuring the light absorbence of all the reaction vessels filled with the reaction solution by the optical measuring mechanism 12 during each operation period;

j. replacing manually the reaction vessels according to the indication of the analyzer after the reactions in the reaction vessels has completed; and

k. computing and outputting the test results after completion of reaction.

According to the operation time sequence of each assembly of the chemistry analyzer, the operation period may be classified into two periods: period for injecting the first reagent and the sample and period for injecting the second reagent. During period for injecting the first reagent and the sample, the probe 5 injects successively the first reagent and the sample and the stirring rod 8 stirs the reaction solution. It should be noted that the probe 5 injects only the first reagent for the first five tests to be run during the first five periods and the probe 5 injects only the sample for the last five tests to be run. The operation of injection of the sample for the last five tests to be run during the same pitch test takes one period respectively. The stirring rod 8 stirs the reaction solution after the sample is injected. During period for injecting the second reagent, the probe 5 injects the second reagent and the stirring rod 8 stirs the reaction solution, thereby completing the injection of the second reagent for the double reagent tests to be run.

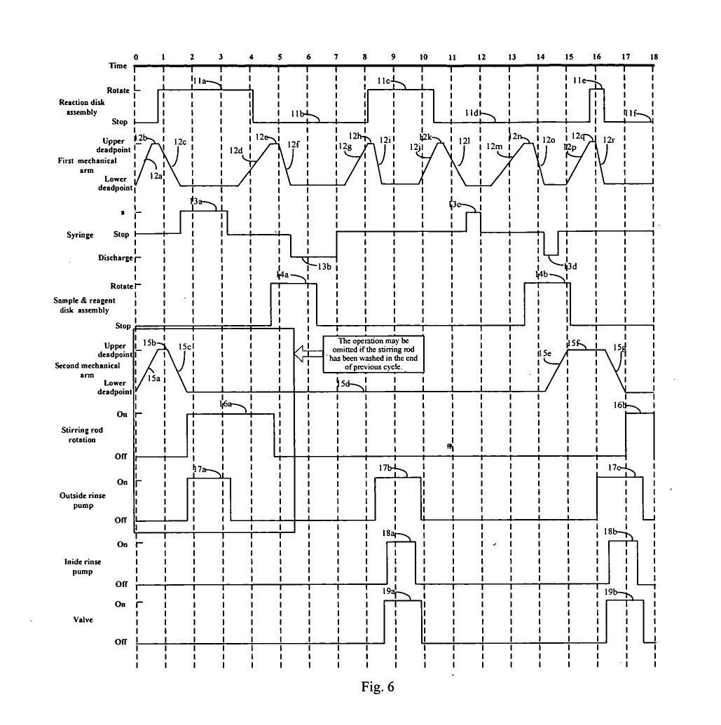

FIG. 6 is a time sequence chart of each assembly of the automatic chemistry analyzer according to the present invention during period for injecting the first reagent and the sample. During this period, the turntable 14 rotates three times (as shown by the segments 11a, 11c, 11e) and stops three times (as shown by the segments 11b, 11d, 11f). During the first rotation (as shown by the segment 11a), the turntable 14 rotates counter-clockwise and successively the eighty reaction vessels through the optical measuring channels 21 of the optical measuring mechanism 12, thereby measuring the light absorbence of the empty reaction vessels and stopping the reaction vessels at a station for injecting the first reagent. During the second rotation (as shown by the segment 11c), the turntable 14 rotates counter-clockwise an angle corresponding to seventy-five reaction vessels and stops the reaction vessels at a station for injecting the sample. During the third rotation (as shown by the segment 11e), the turntable 14 rotates counter-clockwise an angle corresponding to ten reaction vessels and stops the reaction vessels at a station for stirring.

At the start of this period, the probe 5 elevates from a washing tank 7 (as shown by the segment 12a), rotates to the station for sucking the reagent above the sample and reagent disk assembly 2 (as shown by the segment 12b) and lowers into the reagent vessel (as shown by the segment 12c) to suck the reagent (as shown by the segment 13a). After sucking the reagent, the probe 5 elevates from the reagent vessel (as shown by the segment 12d). At this time, the sample and reagent disk assembly 2 rotates and stops at the station for sucking the sample for this period (as shown by the segment 14a) while the probe 5 rotates to the station for injecting the first reagent above the turntable 14(as shown by the segment 12e) and lowers into the reaction vessel (as shown by the segment 12f) to inject the reagent into the reaction vessel (as shown by the segment 13b). After injection of the reagent, the probe 5 elevates from the reaction vessel (as shown by the segment 12g), rotates to the station for washing (as shown by the segment 12h) and lowers into the washing tank (as shown by the segment 12i) to wash the inner and outer walls of the probe. A pump for washing the outer wall (also called “outside rinse pump”), a valve and a pump for washing the inner wall (also called “inside rinse pump”) switch on successively for a predetermined time (as shown by the segments 17b, 18a, 19a) and then switch off. After washing, the probe 5 elevates from the washing tank (as shown by the segment 12j), rotates to the station for sucking the sample above the sample and reagent disk assembly 2 (as shown by the segment 12k) and lowers into the sample vessel (as shown by the segment 12l) to suck the sample (as shown by the segment 13c). After sucking the sample, the probe 5 elevates from the sample vessel (as shown by the segment 12m). At this time, the sample and reagent disk assembly 2 rotates and stops at the station for sucking the reagent for the next period (as shown by the segment 14b) while the probe 5 rotates to the station for injecting the sample above the turntable 14(as shown by the segment 12n) and lowers into the reaction vessel (as shown by the segment 120) to inject the sample into the reaction vessel (as shown by the segment 13d). After injection of the sample, the probe 5 elevates from a reaction vessel (as shown by the segment 12p), rotates to the station for washing (as shown by the segment 12q) and lowers into the washing tank (as shown by the segment 12r) to wash the inner and outer walls of the probe (as shown by the segments 17c, 18b, 19b).

If the stirring rod 8 is not washed at the end of the previous operation period, the stirring rod 8 must elevate from a reaction vessel (as shown by the segment 15a), rotates to the station for washing (as shown by the segment 15b) and lowers into the washing tank 10 (as shown by the segment 15c) to wash the outer walls of the stirring rod 8 at the start of the current period. The motor for stirring and the pump for washing the outer wall switch on for a predetermined time (as shown by the segments 16a, 17a) and then switch off. If the stirring rod 8 has been washed at the end of the previous operation period, the operation would be omitted. During this period, the stirring rod 8 locates in the washing tank (as shown by the segment 15d) until the probe 5 lowers into the reaction vessel to inject the sample into the reaction vessel (as shown by the segments 12o, 13d). At this time, the stirring rod 8 elevates from the washing tank (as shown by the segment 15e), rotates to the station for stirring above the turntable 14 (as shown by the segment 15f) and lowers into a designated reaction vessel (as shown by the segment 15g) to stir the reaction solution while the turntable 14 rotates the designated reaction vessel to the station for stirring. The motor for stirring switches on for a predetermined time (as shown by the segment 16b).

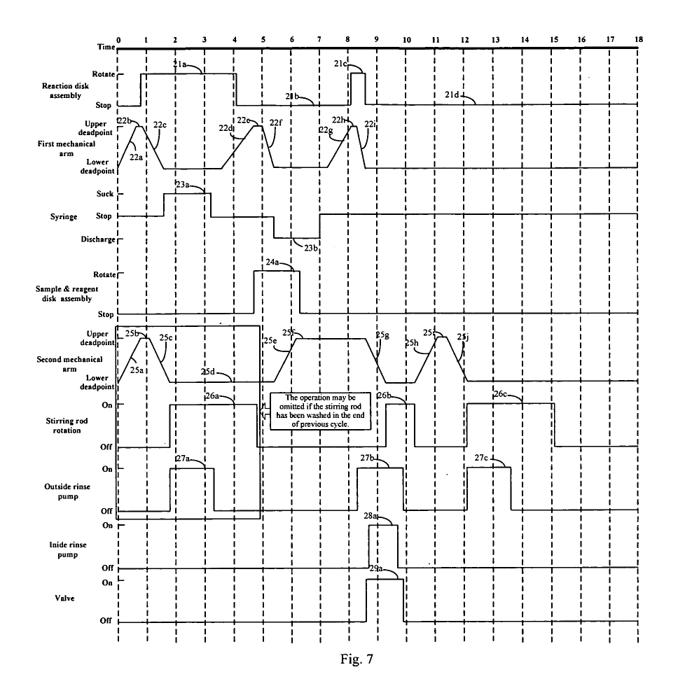

FIG. 7 is a time sequence chart of each assembly of the automatic chemistry analyzer according to the present invention during period for injecting the second reagent. During this period, the turntable 14 rotates twice (as shown by the segments 21a, 21c) and stops twice (as shown by the segments 21b, 21d). During the first rotation (as shown by the segment 21a), the turntable 14 rotates counter-clockwise and successively the eighty reaction vessels through the optical measuring channels 21 of the optical measuring mechanism 12, thereby measuring the light absorbence of the reaction solution and stopping the reaction vessels at the station for injecting the second reagent. During the second rotation (as shown by the segment 21), the turntable 14 rotates counter-clockwise an angle corresponding to ten reaction vessels and stops the reaction vessels at the station for stirring.

At the start of this period, the probe 5 elevates from the washing tank (as shown by the segment 22b), rotates to the station for sucking the second reagent above the sample and reagent disk assembly 2 (as shown by the segment 22b) and lowers into the reagent vessel (as shown by the segment 22c) to suck the second reagent (as shown by the segment 23a). After sucking the second reagent, the probe 5 elevates from the reagent vessel (as shown by the segment 22d). At this time, the sample and reagent disk assembly 2 rotates and stops at the station for sucking the second reagent for the next period (as shown by the segment 24a) while the probe 5 rotates to the station for injecting the second reagent above the turntable 14(as shown by the segment 22e) and lowers into the reaction vessel (as shown by the segment 22f) to inject the second reagent into the reaction vessel (as shown by the segment 23b). After injection of the second reagent, the probe 5 elevates from the reaction vessel (as shown by the segment 22g), rotates to the station for washing (as shown by the segment 22h) and lowers into the washing tank (as shown by the segment 22i) to wash the inner and outer walls of the probe. The pump for washing the outer wall, the valve and the pump for washing the inner wall in the washing tank switch on successively for a predetermined time (as shown by the segments 27b, 28a, 29a) and then switch off.

If the stirring rod 8 is not washed at the end of the previous operation period, the stirring rod 8 must elevate from a reaction vessel (as shown by the segment 12a), rotates to the station for washing (as shown by the segment 25b) and lowers into the washing tank (as shown by the segment 25c) to wash the outer walls of the stirring rod 8 at the start of the current period. The motor for stirring and the pump for washing the outer wall switch on for a predetermined time (as shown by the segments 26a, 27a) and then switch off. If the stirring rod 8 has been washed at the end of the previous operation period, the operation would be omitted. During this period, the stirring rod 8 locates in the washing tank (as shown by the segment 25d) until the probe 5 lowers into the reaction vessel to inject the second reagent into the reaction vessel (as shown by the segments 22f, 23b). At this time, the stirring rod 8 elevates from the washing tank (as shown by the segment 25e), rotates to the station for stirring above the turntable 14 (as shown by the segment 25f) and lowers into a designated reaction vessel (as shown by the segment 25g) to stir the reaction solution while the turntable 14 rotates the special reaction vessel to the station for stirring. The motor for stirring switches on for a predetermined time (as shown by the segments 26b). After completion of stirring, the stirring rod 8 elevates from the reaction vessel (as shown by the segment 12h), rotates to the station for washing (as shown by the segment 25i) and lowers into the washing tank (as shown by the segment 25j) to wash the outer wall of the stirring rod 8. The motor for stirring and the pump for washing the outer wall switch on for a predetermined time (as shown by the segments 26c, 27c) and then switch off.

Having described the invention in detail, those skilled in the art will appreciate that modifications of this invention may be made without departing from its spirit. Therefore, it is not intended to limit the present invention only to the preferred embodiments illustrated and described. Rather, the scope of the invention is to be determined by the appended claims and their equivalents.

What is claimed is:

1. An automatic chemistry analyzer comprising:
a reaction disk assembly (1) comprising a turntable (14), a first driving mechanism for driving the turntable (14) to rotate, a plurality of reaction vessels (11) disposed successively around the circumference of the turntable (14), and an optical measuring mechanism (12) for measuring the light absorbence of each reaction vessel (11) disposed aside of the turntable (14), wherein the turntable (14) and the reaction vessels (11) being disposed in a close and temperature-controlled cavity;
a sample and reagent disk assembly (2) comprising a sample and reagent support (15) and a second driving mechanism for driving the sample and reagent support (15) to rotate, a plurality of holes (17) for receiving the sample vessels and a plurality of holes (18) for receiving the reagent vessels disposed on the sample and reagent support (15), and a refrigerating module disposed below the sample and reagent support (15) to maintain the reagent at a low temperature;
a probe assembly (3) comprising a probe (5), a first mechanical arm (6) for supporting the probe (5), a first driving module for driving the first mechanical arm (6), a syringe, and a fluid path which connects the syringe and the probe, wherein the probe (5) being used to inject both the reagent and the sample into the reaction vessels (11);
a stirring assembly (4) comprising a stirring rod (8), a second mechanical arm (9) for supporting the stirring rod (8), a second driving module for driving the second mechanical arm (9), a stirring driving mechanism disposed in the second mechanical arm (9) to drive the stirring rod (8); and
a circuit and a processing soft for controlling the reaction disk assembly (1), the sample and reagent disk assembly (2), the probe assembly (3) and the stirring assembly (4) to operate harmoniously in analyzing process.

2. An automatic chemistry analyzer as claimed in claim 1, wherein the reaction vessels (11) are disposable and a window (26) is disposed over the reaction disk (1) to replace the reaction vessels (11).

3. An automatic chemistry analyzer as claimed in claim 1, wherein the reaction vessels (11) are disposed around the circumference of the turntable (14) at an equal interval and divided into a plurality of reaction vessel packs (27) each including a group of reaction vessels connected to each other in a segment shape.

4. An automatic chemistry analyzer as claimed in claim 1, wherein the sample and reagent support (15) includes an inner circle and an outer circle, the sample vessels are disposed in the outer circle at an equal interval and the reagent vessels are disposed in the inner circle at an equal interval.

5. An automatic chemistry analyzer as claimed in claim 1, wherein the probe assembly (3) further comprises a capacitive liquid level detector to stop the probe (5) descent when the tip of the probe (5) contacts the surface of liquid and a pre-heating device disposed inside of the first mechanical arm (6) to pre-heat the reagent sucked into the probe (5) to an appropriate temperature, the first mechanical arm (6) is attached to the top end of a first spline shaft (19), and upward and downward movement and rotation of the first spline shaft (19) are controlled precisely by two stepping motors of the first driving module.

6. An automatic chemistry analyzer as claimed in claim 1, wherein the stirring driving mechanism includes a DC motor connected to the stirring rod (8) to rotate the stirring rod (8), the second mechanical arm (9) is attached to the top end of a second spline shaft (20), and upward and downward movement and rotation of the spline shaft (20) are controlled precisely by two stepping motors of the second driving module.

7. An automatic chemistry analyzer as claimed in claim 1, wherein the optical measuring mechanism (12) comprises a plurality of optical measuring channels (21) each corresponding to one measured wavelength, and the reaction vessels (11) pass through the optical measuring channels (21) at a constant velocity to measure the light absorbence of each reaction solution.

8. An automatic chemistry analyzer as claimed in claim 1, wherein the temperature-controlled cavity includes a close cavity and a temperature control system to maintain the reaction temperature at or near a special temperature during the chemical test, a heater and an axial fan are disposed in the temperature-controlled cavity, and the reaction vessels (11) and the turntable (14) are disposed in the temperature-controlled cavity.

9. An automatic chemistry analyzer as claimed in claim 8, wherein the special temperature is human body temperature.

10. An automatic chemistry analyzer as claimed in claim 1, wherein the refrigerating module includes a semiconductor refrigerating element, a heat dispersion passage, a close and thermally insulated cavity and a refrigerating control system to maintain the temperature of the reagent at a lower temperature, thereby reducing volatilisation and elongating period of validity of the reagent.

11. An automatic chemistry analyzer as claimed in claim 1, wherein the first driving mechanism includes a first bearing seat (13) for supporting the turntable (14), a stepping motor (22) and a synchronizing belt (23), the first bearing seat (13) is driven by the stepping motor (22) via the synchronizing belt (23) to rotate and stop precisely the turntable (14) so that one special reaction vessel (11) is located in an injecting postion (30) or a stirring postion (31).

12. An automatic chemistry analyzer as claimed in claim 1, wherein the second driving mechanism includes a second bearing seat (16) for supporting the sample and reagent support (15), a stepping motor (25) and a synchronizing belt (24), the bearing seat (16) is driven by the stepping motor (25) via the synchronizing belt (24) to rotate and stop precisely the sample and reagent support (15) so that one special reagent vessel or sample vessel is located in an reagent-sucking postion (32) or a sample-sucking postion (33).

13. An automatic chemistry analyzer as claimed in claim 2, wherein there are eighty reaction vessels (11) consisting of eight reaction vessel packs (27) each including ten reaction vessels (11) connected to each other, and the reaction vessels is positioned circumferentially by engaging the positioning holes (28) formed in the reaction vessel pack (27) with the corresponding positioning pins (29) provided on the turntable (14) to facilitate manually replacing the reaction vessels (11).

14. An analyzing process for running a single-reagent test using an automatic chemistry analyzer as claimed in claim 1, the analyzing process comprising the following steps:
a). powering-on to self-test and initialize the chemistry analyzer;
b). placing new reaction vessels onto the turntable according to the indication of the chemistry analyzer and measuring the light absorbencee of the empty reaction vessels;
c). using the probe to suck a fixed volume of reagent from a reagent vessel, pre-heating the reagent sucked into the probe by the pre-heating device disposed in the mechanical arm of the probe, injecting the pre-heated reagent into a designated reaction vessel and washing the probe after completion of injection;
d). heating the reagent in the reaction vessel inside of the temperature-controlled cavity of the reaction disk assembly for several operation periods to an appropriate test temperature;
e). using the probe to suck a fixed volume of sample from a sample vessel and inject the same into the reaction vessel, and washing the probe;
f). inserting the stirring rod into the reaction vessel to mix the reagent and the sample in the reaction vessel, and washing the stirring rod after completion of stirring;
g). measuring periodically the light absorbence of the reaction vessel filled with the mixed reagent and sample by the optical measuring mechanism;
h). computing and outputting the test results.

15. An analyzing process as claimed in claim 14, wherein the appropriate test temperature is at or near 37° C.

16. An analyzing process as claimed in claim 14, wherein the step a) comprises resetting the reaction disk assembly, the sample and reagent disk assembly, the probe assembly and the stirring assembly, electrifying the optical measuring mechanism, performing temperature incubation in the temperature-controlled cavity; and starting the test only after the optical measuring mechanism is stable and the temperature-controlled cavity is at a constant temperature of 37° C.

17. An analyzing process for running a double-reagent test using an automatic chemistry analyzer as claimed in claim 1, the analyzing process comprising the following steps:
a). starting and initializing the chemistry analyzer;
b). placing new reaction vessels onto the turntable according to the indication of the analyzer and measuring the light absorbence of the empty reaction vessels;
c). using the probe to suck a fixed volume of the first reagent from a reagent vessel, pre-heating the first reagent sucked into the probe by the pre-heating device disposed in the mechanical arm of the probe, injecting the pre-heated first reagent into a designated reaction vessel and washing the probe after completion of injection;
d). heating the first reagent in the reaction vessel inside of the temperature-controlled cavity of the reaction disk assembly for several operation periods to an appropriate reaction temperature;
e). using the probe to suck a fixed volume of sample from a sample vessel and inject the same into the reaction vessel, and washing the probe;
f). inserting the stirring rod into the reaction vessel to mix the first reagent and the sample in the reaction vessel, and washing the stirring rod after completion of stirring;
g). using the probe to suck a fixed volume of the second reagent from a reagent vessel, pre-heating the second reagent sucked into the probe by the pre-heating device disposed in the mechanical arm of the probe, injecting the pre-heated second reagent into the reaction vessel and washing the probe following injection after an incubation time necessary for the double-reagent test has passed;
h). inserting the stirring rod into the reaction vessel to mix the first reagent, the sample and the second reagent in the reaction vessel, and washing the stirring rod after completion of stirring;
g). measuring the light absorbence of the reaction vessel filled with the reaction solution by the optical measuring mechanism; and
h). computing and outputting the test results.

18. An analyzing process as claimed in claim 17, wherein the appropriate reaction temperature is at or near 37° C.

19. An analyzing process as claimed in claim 17, wherein the step a) comprises resetting the reaction disk assembly, the sample and reagent disk assembly, the probe assembly and the stirring assembly, electrifying the optical measuring mechanism, performing temperature incubation in the temperature-controlled cavity; and starting the test only after the optical measuring mechanism is stable and the temperature-controlled cavity is at a constant temperature of 37° C.

20. An analyzing process for testing successively a plurality of single-reagent tests or double-reagent tests using an automatic chemistry analyzer as claimed in claim 1, the analyzing process comprising the following steps:
a). starting and initializing the chemistry analyzer, and numbering all tests in order;
b). placing new reaction vessels onto the turntable according to the indication of the analyzer and measuring the light absorbence of the empty reaction vessels;
c). using successively the probe to suck the reagent or the first reagent corresponding to the first to the N^{th} test from a reagent vessel and inject the same into the first to the N^{th} reaction vessel, and washing the probe after completion of each injection during each operation period from the first to the N^{th} operation period;
d). using the probe to suck the reagent or the first reagent corresponding to the N+1^{th} test from the reagent vessel and inject the same into the N+1^{th} reaction vessel, washing the probe, using the probe to suck the sample corresponding to the first test from the sample vessel and inject the same into the first reaction vessel, washing the probe after injection of the sample, then using the stirring rod to stir the first reaction vessel into which the sample is injected and washing the stirring rod during the N+1^{th} operation period;
e). using the probe to suck the reagent or the first reagent corresponding to the successive testes following the N+1^{th} test from the reagent vessels and inject the same into the successive reaction vessels following the N+1^{th} reaction vessel, washing the probe, using the probe to suck the sample corresponding to the successive tests following the first test and inject the same into the successive reaction vessels following the first reaction vessel, washing the probe after injection of the sample, then using the stirring rod to stir the reaction vessel into which the sample is injected and washing the stirring rod during each operation period after the N+1^{th} operation period;
f). using the probe to suck the second reagent necessary for a double-reagent test from the reagent vessels and inject the same into the respective reaction vessel, washing the probe, then using the stirring rod to stir the reaction vessels into which the second reagent is injected and washing the stirring rod during an operation period after an incubation time necessary for the double-reagent test has passed;
g). restoring the operation of injecting the reagent or the first reagent and the sample during each operation period after completion of injecting the second reagent;
h). using successively the probe to suck the sample corresponding to the last N tests and inject the same into the respective reaction vessels, washing the probe after each injection of the sample, then using the stirring rod to stir the reaction vessels into which the sample is injected and washing the stirring rod respectively during each operation period;
i). measuring the light absorbence of all the reaction vessels filled with the reaction solution by the optical measuring mechanism during each operation period;
j). replacing manually the reaction vessels according to the indication of the analyzer after the reactions performed in the reaction vessels has completed; and
k). computing and outputting the test results.

21. An analyzing process as claimed in claim 20, wherein the step a) comprises resetting the reaction disk assembly, the sample and reagent disk assembly, the probe assembly and the stirring assembly, electrifying the optical measuring mechanism, performing temperature incubation in the temperature-controlled cavity; and starting the test only after the optical measuring mechanism is stable and the temperature-controlled cavity is at a constant temperature of 37° C.

22. An analyzing process as claimed in claim 20, wherein the value of N is in a range of between 1 and 30.

23. An analyzing process as claimed in claim 22, wherein the value of N is 5, 6 or 7.
